(19) United States
(12) Patent Application Publication
(10) Pub. No.: US 2026/0126545 A1
(43) Pub. Date: May 7, 2026

(54) FREQUENCY SELECTIVE SURFACE WITH TUNABLE RADAR CROSS SECTION

(71) Applicant: AIRBORNE OUTFITTERS LLC, Findlay, OH (US)

(72) Inventors: Jason Brett Evatt, Findlay, OH (US); Wesley R. Bonin, Hallsville, TX (US); Kenneth Fritsch, Arnold, MD (US)

(21) Appl. No.: 19/380,216

(22) Filed: Nov. 5, 2025

Related U.S. Application Data
(60) Provisional application No. 63/716,265, filed on Nov. 5, 2024.

(51) Int. Cl. G01S 13/75; G01S 7/02; G01S 7/03; G01S 7/42

(52) U.S. Cl. CPC G01S 13/753; G01S 7/027; G01S 7/03; G01S 7/42; G01S 13/756

(57) ABSTRACT

A system for communication can include a frequency selective surface having a tunable radar cross section configured to receive an electromagnetic signal. The frequency selective surface can include an isolation layer, a plurality of conductive elements disposed on a first side of the isolation layer, and a plurality of tunable components, each coupled with a respective conductive element. A control system can be configured to adjust a bias voltage applied to the tunable components to modulate the radar cross section of the frequency selective surface and encode binary data in a reflected electromagnetic signal. A radar system can be configured to transmit the electromagnetic signal and receive the reflected electromagnetic signal. The frequency selective surface can operate within a frequency band corresponding to an operational frequency of the radar system to enable adaptive, reflected-signal communication.

### CROSS-REFERENCE TO RELATED APPLICATIONS

This application claims the benefit of U.S. Provisional Application No. 63/716,265, filed on November 5, 2024. The entire disclosure of the above application is incorporated herein by reference.

### FIELD

The present technology relates to frequency selective surfaces with tunable radar cross section capabilities and, more particularly, to a system and method for modulating an electromagnetic property of a frequency selective surface for communication.

### INTRODUCTION

This section provides background information related to the present disclosure which is not necessarily prior art.

A frequency selective surface is an engineered structure that can interact with electromagnetic waves in a frequency-dependent manner. The frequency selective surface can include a patterned arrangement of conductive elements supported by a dielectric or composite substrate, forming a surface capable of filtering, reflecting, absorbing, or transmitting specific frequency bands of incident radiation. Because of this selective interaction, the frequency selective surface can function as a spatial filter, reflector, or absorber that can provide controlled electromagnetic responses across microwave, millimeter-wave, and other frequency ranges. These characteristics can make the frequency selective surface useful in applications such as antennas, radomes, electromagnetic shielding, sensing, and radar systems.

The frequency selective surface can exhibit fixed electromagnetic characteristics that are determined by geometry and materials. While effective in static environments, the frequency selective surface can lack adaptability to changing conditions, signal requirements, or operational objectives. To address this limitation, tunable frequency selective surfaces can be provided that incorporate controllable elements capable of altering surface impedance or resonance properties. These tunable designs can enable adjustment of reflection or transmission characteristics across selected frequency bands for more flexible electromagnetic management.

Both static and tunable frequency selective surfaces, however, can encounter performance and integration challenges. Certain tunable frequency selective surfaces can suffer from limited tuning range, high insertion loss, and slow response times, which can reduce their effectiveness in practical applications. Integration with radar or communication platforms can be complicated by interactions with automatic gain control systems or by variations in signal stability.

Accordingly, there is a need for a system and method for communication utilizing a frequency selective surface having a tunable radar cross section that can provide reliable, dynamic, and controllable modulation of electromagnetic properties to encode binary data while maintaining compatibility with existing electronic architectures.

### SUMMARY

In concordance with the instant disclosure, systems and methods for communication utilizing a frequency selective surface having a tunable radar cross section, have surprisingly been discovered. The present technology includes articles of manufacture, systems, and processes that relate to communication utilizing a frequency selective surface having a tunable radar cross section that can provide reliable, dynamic, and controllable modulation of electromagnetic properties to encode binary data while maintaining compatibility with existing electronic architectures.

In certain embodiments, a system for communication is provided. The system can include a frequency selective surface having a tunable radar cross section configured to receive an electromagnetic signal. The frequency selective surface can include an isolation layer, a plurality of conductive elements disposed on a first side of the isolation layer, and a plurality of tunable components. Each tunable component can be coupled with a respective conductive element. A control system can be configured to adjust a bias voltage applied to each tunable component to modulate the radar cross section of the frequency selective surface and encode binary data in a reflected electromagnetic signal. A radar system can be configured to transmit the electromagnetic signal and receive the reflected electromagnetic signal. The frequency selective surface can operate within a frequency band corresponding to an operational frequency of the radar system.

In certain embodiments, a method for communication is provided. The method can include transmitting an electromagnetic signal toward a frequency selective surface having a tunable radar cross section. A bias voltage applied to a plurality of tunable components of the frequency selective surface can be adjusted to modulate the radar cross section and encode binary data in a reflected electromagnetic signal. Modulating can include switching the frequency selective surface between a high radar cross section state representing a binary one and a low radar cross section state representing a binary zero to facilitate communication through radar reflection modulation. The method can further include decoding the binary data from the reflected electromagnetic signal.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram illustrating a system for communication, according to certain embodiments of the present disclosure;

FIG. 2 is a perspective view of a frequency selective surface, according to certain embodiments of the present disclosure; and

FIGS. 3-4 provide a flow chart illustrating a method for communication, according to certain embodiments of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1–10, or 2–9, or 3–8, it is also envisioned that Parameter X may have other ranges of values including 1–9, 1–8, 1–3, 1–2, 2–10, 2–8, 2–3, 3–10, 3–9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology relates to systems and methods for communication, including communication. Communication can be achieved by modulating a radar cross section of a frequency selective surface in a controlled manner to encode information in a reflected electromagnetic signal. By varying a reflectivity of the frequency selective surface over time, the frequency selective surface can generate a sequence of high and low reflection states that correspond to binary data. For instance, a high-reflectivity state (e.g., high radar cross section) can represent a binary one while a low-reflectivity state (e.g., low radar cross section) can represent a binary zero. When the modulated reflected electromagnetic signals are received and processed by a compatible radar or reflected electromagnetic signal processor, the encoded binary pattern can be decoded to recover the transmitted information. To an external or conventional radar system, however, the variations in reflection may appear as normal fluctuations or noise, thereby concealing the presence of the communication signal and maintaining a low probability of detection.

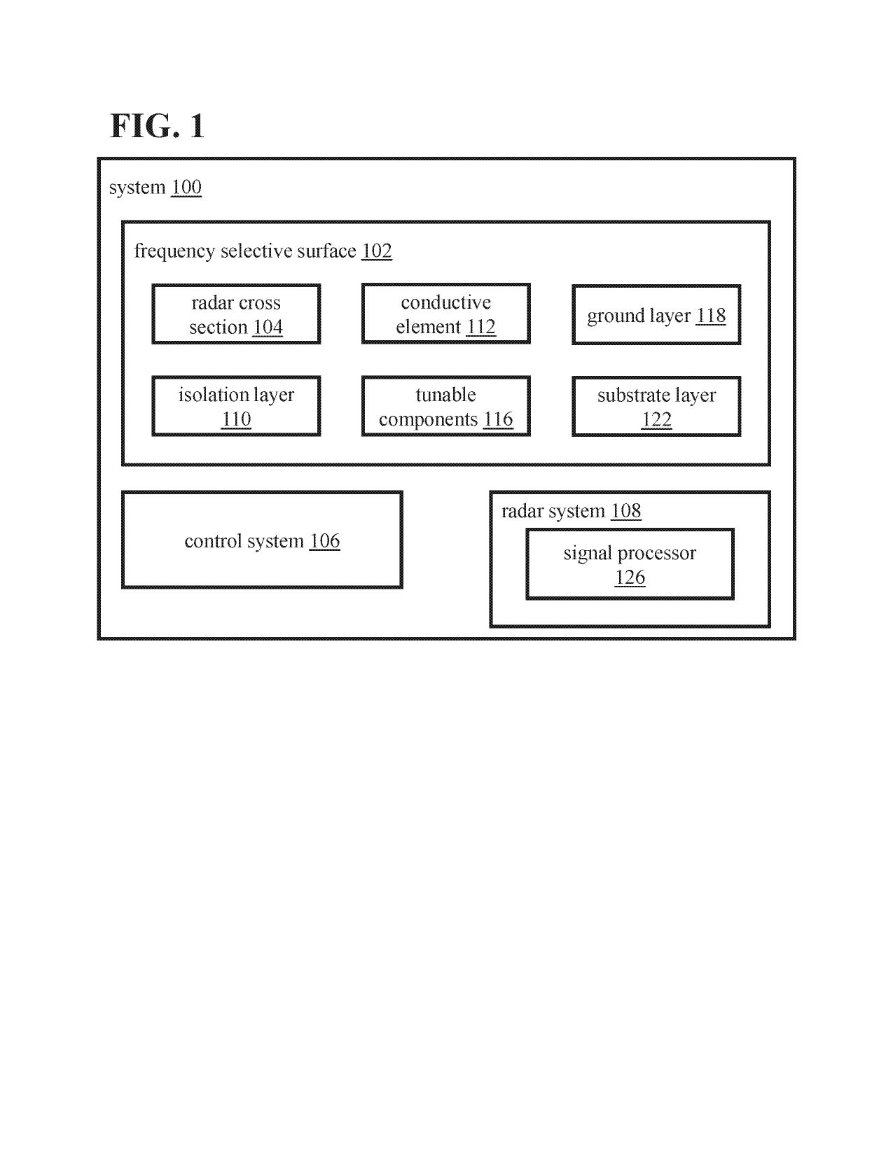

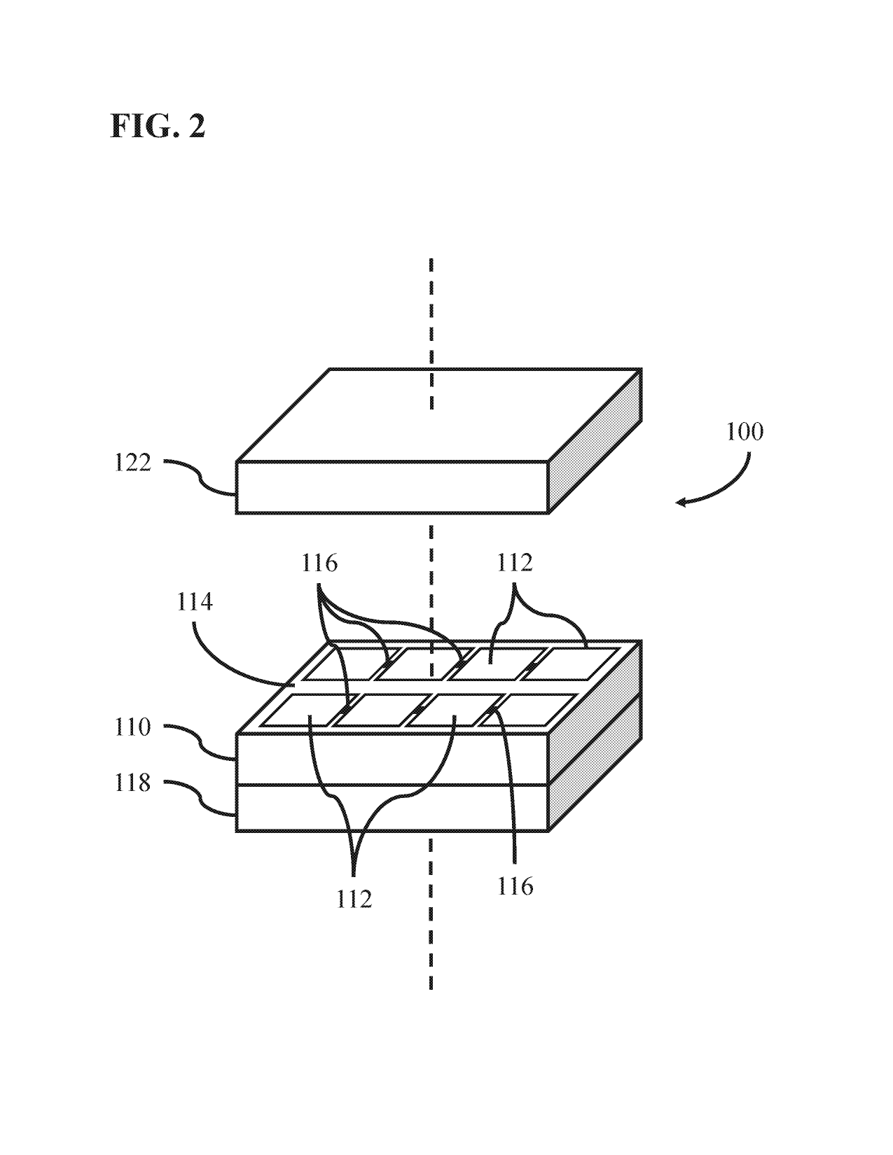

Referring now to the drawings, in certain embodiments, and with reference to FIGS. 1-2, a system 100 for communication is provided. The system 100 can include a frequency selective surface 102 having a tunable radar cross section 104 configured to receive an electromagnetic signal. The system 100 can include a control system 106 configured to vary an electromagnetic response of the frequency selective surface 102, thereby modulating the radar cross section 104 of the frequency selective surface 102. The system can include a radar system 108 configured to transmit the electromagnetic signal and receive a reflected electromagnetic signal. Further aspects of the frequency selective surface 102, the control system 106, and the radar system 108, including their respective structures and interactions, are described in greater detail herein.

In certain embodiments, the frequency selective surface 102 can include an isolation layer 110 that can electrically and mechanically separate different functional layers. The isolation layer 110 can provide electrical insulation between conductive regions while maintaining structural integrity. The thickness and dielectric properties of the isolation layer 110 can be selected to support the desired frequency response of the frequency selective surface 102. The isolation layer 110 can also assist in maintaining uniform spacing between adjacent elements of the structure to ensure consistent electromagnetic behavior.

In certain embodiments, a plurality of conductive elements 112 can be disposed on a first side 114 of the isolation layer 110. Each conductive element 112 of the plurality of conductive elements 112 can include a material such as copper, aluminum, gold, or a conductive composite deposited or patterned onto the isolation layer 110. Each conductive element 112 of the plurality of conductive elements 112 can be shaped and sized to define a specific resonant frequency or range of frequencies. The plurality of conductive elements 112 can be arranged in an array, a repeating pattern, one-dimensional or two-dimensional configurations, or other spatial arrangements suitable for defining desired electromagnetic responses.

The plurality of conductive elements 112 can include a multi-pole element or N-pole type element, a loop type element, a plate type element, and combinations thereof. Each type of conductive element 112 can exhibit reflection and transmission properties within the selected frequency band. Multi-pole elements can generate multiple resonant modes, while loop or plate elements can provide broadband responses.

When the plurality of conductive elements 112 include the multi-pole element, the multi-pole element can include a dipole, a tri-pole, a Jerusalem cross, a cross-dipole, a spiral, and combinations thereof. Each configuration of multi-pole element can create distinct electromagnetic resonances based on geometry and spacing from respective multi-pole elements. The multi-pole design can allow the frequency selective surface 102 to respond to multiple polarizations or frequency components.

When the plurality of conductive elements 112 include the loop type element, the loop type element can include a multi-legged shape, a circular loop, a square loop, a hexagonal loop, and combinations thereof. The shape and size of each loop type element can determine the resonant frequency and bandwidth of the frequency selective surface 102. The loop type element can provide polarization-insensitive reflection and broad operational bandwidths. The loop type element can provide broadband or narrowband responses. The loop type element can provide polarization-insensitive reflection and broad operational bandwidths. The loop type element can provide broadband or narrowband responses. Advantages of a broadband response or wideband resonant mode can include reduced dependence on specific radar systems and the ability to communicate across a wider range of platforms. Such broadband operation can, however, occur at the expense of low probability of intercept and low probability of exploitation performance. Advantages of narrowband responses and resonant modes can include low probability of intercept and low probability of exploitation, as the device or operator can interact with a smaller portion of the electromagnetic spectrum, making it more difficult for an adversary to detect or exploit communications.

When the plurality of conductive elements 112 include the plate type element, the plate type element can include a planar conductive region configured to reflect incident electromagnetic energy. The plate type element can include shapes such as rectangular, square, triangular, or polygonal geometries, depending on desired frequency response characteristics. The dimensions and spacing of each plate type element can be selected to achieve a specific resonance or reflection phase across the frequency band of operation.

Various configurations of the conductive elements 112 can provide advantages depending on specific operational criteria. For example, when polarization of the radar system 108 is unknown, a circular conductive element can be advantageous due to its polarization-independent behavior. Circular elements can also resonate at approximately one-third of a frequency’s wavelength, providing a size advantage for compact implementations of the frequency selective surface 102. Other types of conductive elements can exhibit their own performance benefits. Cross-dipole elements can resonate at approximately one-half of a frequency’s wavelength and can do so with higher efficiency than circular elements, producing increased reflected energy and a larger radar cross section 104. Spiral elements can be utilized as wideband components capable of resonating over a broad range of frequencies, allowing operation across multiple radar bands. Jerusalem cross elements can demonstrate improved angular stability, maintaining a desired electromagnetic response at incidence angles deviating from an ideal ninety-degree orientation.

In certain embodiments, a plurality of tunable components 116 can be operatively coupled with the plurality of conductive elements 112 to enable modulation of the radar cross section 104. Each tunable component 116 can be coupled to a respective conductive element 112. Each tunable component 116 of the plurality of tunable components 116 can alter an impedance, a capacitance, and a resistance of the frequency selective surface 102, thereby varying the reflective behavior of the frequency selective surface 102.

Each tunable component 116 can include a varactor diode, a PIN diode, a microelectromechanical system (MEMS) switch, a graphene layer, or a liquid crystal element. The PIN diode can vary its electrical impedance when biased. The PIN diode can be integrated directly onto or adjacent to a respective conductive element 112 of the plurality of the conductive elements 112. By applying a voltage from the control system 106, the PIN diode conductivity can be changed, thereby altering the reflectivity of the frequency selective surface 102. The PIN diode can allow for rapid switching between radar cross section states or fine modulation of amplitude and phase.

In certain embodiments, the frequency selective surface 102 can include a ground layer 118 disposed on a second side 120 of the isolation layer 110 opposite the plurality of conductive elements 112. The ground layer 118 can serve as a conductive plane that reflects electromagnetic energy and militates against transmission through the frequency selective surface 102. The inclusion of the ground layer 118 can create a reflective or resonant cavity that increases the radar cross section 104. The ground layer 118 can be formed of a continuous metallic sheet or a patterned conductive film depending on performance requirements.

In certain embodiments, the frequency selective surface 102 can include a substrate layer 122. The substrate layer 122 can be disposed on the first side 114 of the isolation layer 110 adjacent to the conductive elements 112. The substrate layer 122 can provide structural support and can protect the conductive elements 112 from environmental exposure. The dielectric constant, dissipation factor, and thickness of the substrate layer 122 can affect electrical properties of the frequency selective surface 102, such as impedance and resonant frequency. These effects can be frequency dependent, with some substrate materials influencing the electrical behavior more strongly at lower frequencies in the megahertz range or higher frequencies in the gigahertz range. Substrate materials such as the Rogers Corporation’s RO4003C can be utilized, which can maintain substantially constant electrical properties centered at 10 GHz.

The substrate layer 122 can include a material such as a polymer, a ceramic, a glass, a composite, and combinations thereof. The material selection can depend on desired thermal stability, dielectric performance, and manufacturability. Polymers can provide flexibility and low weight, whereas ceramics and glasses can offer rigidity and temperature tolerance. Composite configurations of these materials can also be used to achieve a balance between mechanical and electrical properties.

When the substrate layer 122 includes a polymer, the polymer can include polytetrafluoroethylene, polyimide, polyethylene terephthalate, polycarbonate, and combinations thereof. These polymeric materials can provide low dielectric loss and good mechanical stability under varying environmental conditions. The polymer composition can be chosen to maintain predictable electromagnetic performance across a wide frequency range. The surface of the polymer layer can be metallized or coated to enhance adhesion with the conductive elements 112.

When the substrate layer 122 includes a ceramic, the ceramic can include alumina, silicon nitride, and combinations thereof. Ceramics can exhibit high dielectric constants, making them suitable for compact high-frequency applications. The use of a ceramic substrate can improve heat dissipation for systems operating at elevated power levels. The ceramics can be manufactured using thin-film or multilayer fabrication processes to integrate with the frequency selective surface 102.

When the substrate layer 122 includes a glass, the glass can include quartz, borosilicate glass, and combinations thereof. Glass materials can provide optical transparency, dimensional stability, and low dielectric loss. The smooth surface of the glass can contribute to consistent element geometry and predictable resonance characteristics.

In certain embodiments, the control system 106 can be configured to adjust a bias voltage applied to the tunable components 116; e.g., PIN diodes. The control system 106 can include a programmable power source, bias control circuitry, and a signal interface. Changes in bias voltage can vary electromagnetic response of the frequency selective surface 102. By varying the bias voltage, the control system 106 can modulate the radar cross section 104 of the frequency selective surface 102, thereby altering the reflectivity of the frequency selective surface 102 to encode binary data into the reflected electromagnetic signal. When the bias voltage is changed, an impedance of the tunable components 116 can shift, thereby altering the reflection coefficient of the frequency selective surface. The change in reflectivity of the frequency selective surface 102 can translate into detectable amplitude variations or phase shifts in the reflected electromagnetic signal. This modulation of the radar cross section of the frequency selective surface 102 can be used to embed digital information within radar reflections for communication purposes.

The control system 106 can adjust the bias voltage to modulate the frequency selective surface 102 between a high radar cross section state and a low radar cross section state. The transition between the high radar cross section state and low radar cross section state can occur in microseconds or faster depending on the tunable component 116 (e.g., PIN diode) response times, for example. The difference between the high radar cross section state and low radar cross section state can correspond to a measurable change in reflected electromagnetic signal strength. Such modulation can be used to represent binary information or other encoded data.

In certain embodiments, an increase in the bias voltage can cause the frequency selective surface 102 to transition to the low radar cross section state. In this condition, the tunable component 116 (e.g., PIN diode) can exhibit high conductivity, effectively short-circuiting portions of the conductive elements 112 and reducing reflection of the frequency selective surface. The low radar cross section state can be associated with diminished signal amplitude detectable by the radar system 108. The low radar cross section state can represent a binary of zero.

A decrease in the bias voltage can cause the frequency selective surface 102 to transition to the high radar cross section state. In this condition, the tunable component 116 (e.g., PIN diode) can present a higher impedance, allowing greater reflection from the conductive elements 112. The high radar cross section state can yield stronger reflected signals detectable by the radar system 108. The high radar cross section state can be associated with the representation of a binary one in encoded communication. When the system 100 alternates between the high radar cross section state and low radar cross section state, binary data can be generated in the reflected electromagnetic signal. The radar system 108 can interpret variations in the reflected electromagnetic signal. Such operation can allow covert or low-probability-of-intercept communication.

In certain embodiments, the control system 106 can be configured to synchronize modulation of the radar cross section 104 of the frequency selective surface 102 with the electromagnetic signal transmitted by the radar system 108. Synchronization can ensure that modulation of the radar cross section 104 occur during specific electromagnetic signal intervals or waveform cycles. This coordination can improve data accuracy and reduce interference between modulation states. The control system 106 can include timing circuits or digital processors to achieve synchronization with high precision.

In certain embodiments, the system 100 can include a radar system 108 configured to transmit the electromagnetic signal and receive the reflected electromagnetic signal. The radar system 108 can generate pulses or continuous electromagnetic signals at frequencies corresponding to a frequency band of the frequency selective surface 102. The radar system 108 can detect the reflected electromagnetic signals.

The radar system 108 can include a signal processor 126 configured to decode variations in the reflected electromagnetic signal corresponding to the encoded binary data. The signal processor 126 can analyze amplitude, phase, or frequency differences in the reflected waveform. Through algorithmic processing, the signal processor 126 can reconstruct the binary sequence encoded by the frequency selective surface 102. The output of the signal processor 126 can then be provided to downstream communication or control systems for interpretation.

The frequency selective surface 102 can be configured to operate within a frequency band corresponding to an operational frequency of the radar system 108. The frequency band can be selected so that resonance effects from the conductive elements 112 are aligned with the radar transmission spectrum. This correspondence can allow efficient modulation and reflection of radar signals. The design of the conductive elements 112 and tunable components 116 can therefore be optimized for operation in that frequency band.

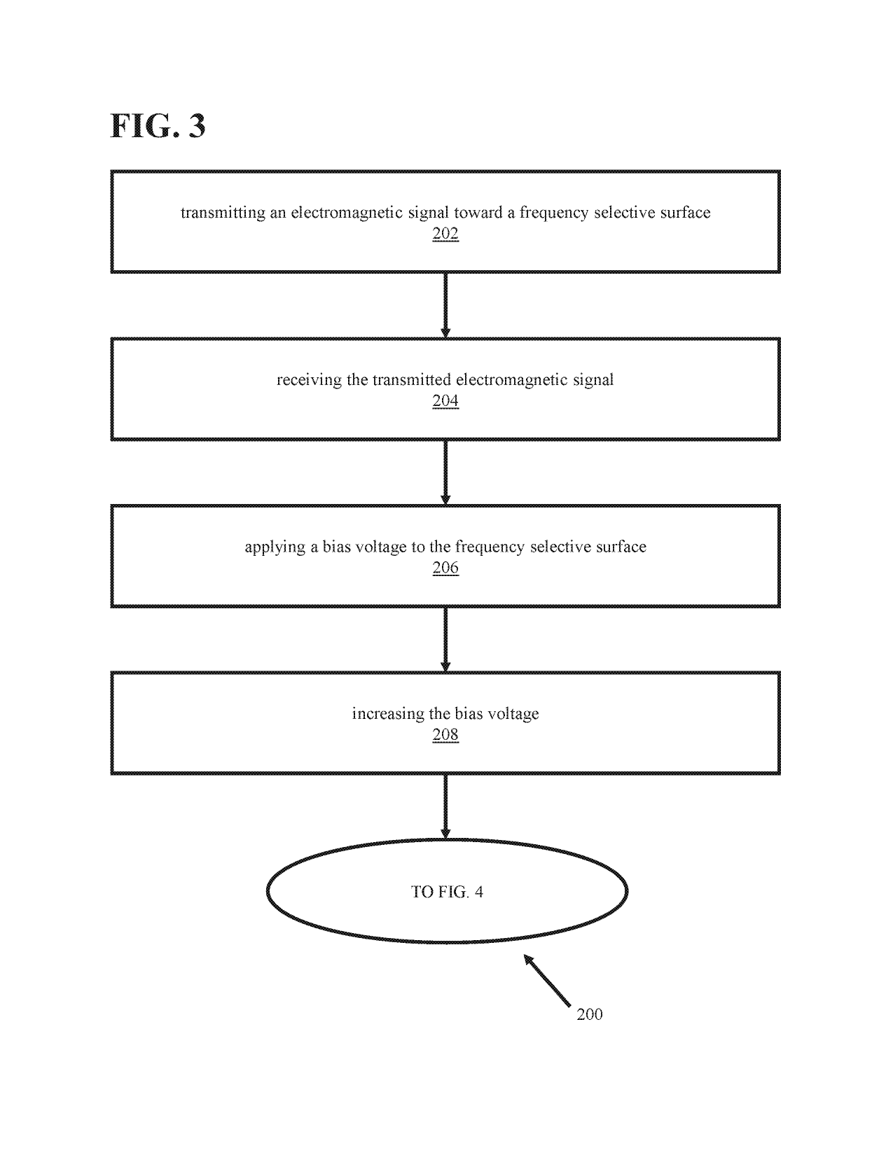

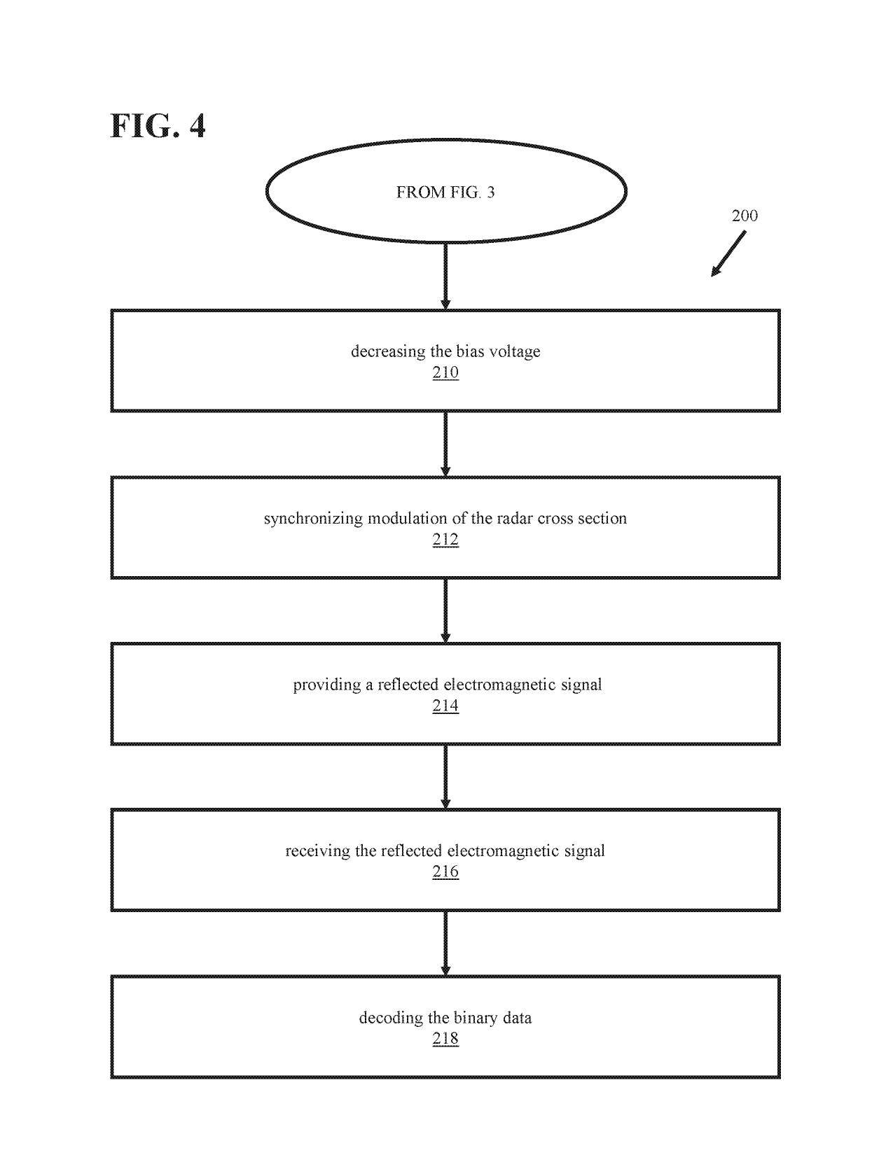

In certain embodiments, and with reference to FIGS. 3-4, a method 200 for communication is provided. The method 200 can include a sequence of steps that enable modulation of a radar cross section 104 of a frequency selective surface 102 for communication using reflected electromagnetic signals. The method 200 can be executed using an embodiment of the system 100 described herein, but reference to the system 100 is made only to facilitate understanding. It should be understood that portions of the system 100, multiple systems 100, and other devices and systems can be included in the operations described in the method 200. Each step of the method 200 can be implemented through electronic or computational control to achieve reliable modulation and data transfer. The frequency selective surface 102 can operate within a frequency band corresponding to an operational frequency of the radar system 108. Matching the operational frequency can allow efficient reflection and modulation of the transmitted electromagnetic signal. The frequency alignment can also support predictable radar cross section behavior across the modulation range. The selection of the operational band can depend upon system design or application requirements.

In a step 202, an electromagnetic signal can be transmitted toward the frequency selective surface 102. The electromagnetic signal can be generated by a radar system 108 or another electromagnetic source operating within a predetermined frequency band. The transmitted electromagnetic signal can propagate through free space until it impinges upon the frequency selective surface 102, where a portion of the incident energy can be reflected. The frequency and polarization of the electromagnetic signal can be selected to correspond with the operational characteristics of the frequency selective surface 102.

In a step 204, the frequency selective surface 102 can receive the transmitted electromagnetic signal. The frequency selective surface 102 can be configured to respond to the incident energy by producing a reflected signal having a radar cross section 104 that is variable in magnitude or phase. The interaction between the incident wave and the frequency selective surface 102 can depend upon the instantaneous configuration of the tunable components 116. The reflection can thus be controlled indirectly through electrical signals applied to those components.

In a step 206, a bias voltage can be applied to the tunable components 116 of the frequency selective surface 102 and varied to modulate the radar cross section 104 of the frequency selective surface 102. The bias voltage can be generated or managed by a control system 106 that regulates the electrical potential across each tunable component 116. Adjustment of the bias voltage can modify an electromagnetic property of the frequency selective surface 102, such as impedance or conductivity, to change the reflected electromagnetic signal characteristics. Variations in voltage can cause corresponding changes in reflection amplitude or phase, thereby producing a pattern of reflected electromagnetic signals. Each voltage adjustment can represent a discrete state that encodes information in the reflected waveform. The modulation can occur continuously, periodically, or according to a predetermined data sequence.

The radar cross section 104 can be switched between a high radar cross section state and a low radar cross section state. The high radar cross section state can correspond to an increased reflectivity, while the low radar cross section state can correspond to a reduced reflectivity. These two distinct reflection conditions can represent binary values of one and zero, respectively. The alternating pattern of these radar cross section states can define a stream of binary data encoded into the reflected electromagnetic signal.

In a step 208, the bias voltage can be increased to transition the frequency selective surface 102 to the low radar cross section state. When the bias voltage is elevated, the tunable components 116 can exhibit greater conductivity, resulting in partial cancellation of reflected energy. The reflected signal under this condition can have reduced amplitude relative to the incident signal. The low radar cross section state can therefore represent a binary zero during data encoding.

In a step 210, the bias voltage can be decreased to transition the frequency selective surface 102 to the high radar cross section state. A reduction in bias voltage can increase impedance across the tunable components 116, leading to greater reflection from the conductive elements 112. The reflected electromagnetic signal can therefore appear stronger to the radar system 108. The high radar cross section state can represent a binary one in the encoded communication sequence.

In a step 212, the modulation of the radar cross section 104 can be synchronized with transmission timing of the electromagnetic signal. Synchronization can ensure that voltage adjustments correspond with radar pulse intervals or other time-domain features of the transmitted waveform. Such coordination can minimize interference and improve decoding accuracy. The timing relationship can be maintained through control algorithms executed by the control system 106.

In a step 214, a reflected electromagnetic signal can be provided as a result of interaction between the electromagnetic signal and the frequency selective surface 102. The reflected electromagnetic signal can include amplitude and phase characteristics that vary according to the instantaneous radar cross section 104 of the frequency selective surface 102. When the control system 106 adjusts the bias voltage applied to the tunable components 116, the reflection characteristics can change accordingly. The reflected electromagnetic signal can therefore carry binary or analog information corresponding to the modulation pattern imposed by the bias voltage variation.

In a step 216, the reflected electromagnetic signal can be received by the radar system 108. The received signal can include amplitude and phase variations produced by the modulated radar cross section 104. These variations can represent the binary data encoded during previous steps. The radar system 108 can process the reflected signal to extract useful information or communication content.

In a step 218, decoding of the binary data can be performed based on characteristics of the reflected electromagnetic signal. Decoding can include analysis of signal amplitude, phase, or timing differences corresponding to the high and low radar cross section states. A signal processor within the radar system 108 can compare the received waveform with expected modulation patterns. The decoded data can then be interpreted as a binary communication sequence. Analysis of the reflected electromagnetic signal can be conducted to determine the pattern of radar cross section modulation. This analysis can be performed through computational processing, signal filtering, or correlation techniques. The extracted pattern can be matched to the binary sequence that was encoded through radar cross section variation. The resulting information can then be output to a receiving interface or communication system.

The method 200 can optionally include repeated modulation cycles to transmit successive sequences of encoded binary data. Each cycle can consist of alternating high and low radar cross section states to form a continuous data stream. The repetition can be controlled by timing signals generated by the control system 106. This process can permit continuous or burst-mode communication using the reflected electromagnetic energy.

Performance of the method 200 can be adjusted by varying modulation rate, voltage magnitude, and/or timing intervals. Such adjustments can optimize data throughput or signal integrity depending on operational requirements. The parameters can be adapted automatically based on feedback from the radar system 108. This adaptive capability can improve communication reliability under changing environmental or system conditions.

The method 200 can terminate following completion of data transmission or upon cessation of radar operation. Termination can occur when modulation signals are discontinued or when the radar system 108 no longer transmits electromagnetic energy toward the frequency selective surface 102. Once the transmission cycle concludes, the frequency selective surface 102 can return to an inactive or standby state. The method 200 can then be reinitiated as needed to perform subsequent communication sequences.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A system for communication, comprising:
a frequency selective surface having a tunable radar cross section configured to receive an electromagnetic signal, the frequency selective surface comprising:
an isolation layer;
a plurality of conductive elements disposed on a first side of the isolation layer; and
a plurality of tunable components, each tunable component coupled with a respective conductive element of the plurality of conductive elements;
a control system configured to adjust a bias voltage applied to each tunable component of the plurality of tunable components to modulate a radar cross section of the frequency selective surface to encode binary data in a reflected electromagnetic signal following receipt of the electromagnetic signal by the frequency selective surface;
a radar system configured to transmit the electromagnetic signal and receive the reflected electromagnetic signal; and
the frequency selective surface is configured to operate within a frequency band corresponding to an operational frequency of the radar system.

2. The system of claim 1, wherein the frequency selective surface includes a ground layer disposed on a second side of the isolation layer opposite the plurality of conductive elements.

3. The system of claim 2, wherein the frequency selective surface includes a substrate layer disposed on the first side of the isolation layer.

4. The system of claim 3, wherein the substrate layer includes a member selected from a group consisting of a polymer, a ceramic, a glass, a composite, and combinations thereof.

5. The system of claim 4, wherein the substrate layer includes the polymer and the polymer includes a member selected from a group consisting of polytetrafluoroethylene, polyimide, polyethylene terephthalate, polycarbonate, and combinations thereof.

6. The system of claim 4, wherein the substrate layer includes the ceramic and the ceramic includes a member selected from a group consisting of alumina, silicon nitride, and combinations thereof.

7. The system of claim 4, wherein the substrate layer includes the glass and the glass includes a member selected from a group consisting of quartz, borosilicate glass, and combinations thereof.

8. The system of claim 1, wherein the plurality of conductive elements includes a member selected from a group consisting of an N-pole type element, a loop type element, a plate type element, and combinations thereof.

9. The system of claim 8, wherein the plurality of conductive elements includes the N-pole type element and the N-pole type element includes a member selected from a group consisting of a dipole, a tri-pole, a Jerusalem cross, a cross-dipole, a spiral, and combinations thereof.

10. The system of claim 8, wherein the plurality of conductive elements includes the loop type element and the loop type element includes a member selected from a group consisting of a multi-legged element, a circular loop, a square loop, a hexagonal loop, and combinations thereof.

11. The system of claim 1, wherein each tunable component of the plurality of tunable components includes a PIN diode.

12. The system of claim 11, wherein the control system is configured to adjust the bias voltage applied to each PIN diode to modulate the frequency selective surface between a high radar cross section state and a low radar cross section state.

13. The system of claim 12, wherein an increase to the bias voltage modulates the frequency selective surface to the low radar cross section state.

14. The system of claim 12, wherein a decrease to the bias voltage modulates the frequency selective surface to the high radar cross section state.

15. The system of claim 12, wherein the high radar cross section state represents a binary of 1.

16. The system of claim 12, wherein the low radar cross section state represents a binary of 0.

17. The system of claim 1, wherein the radar system comprises a signal processor configured to decode a variation in the reflected electromagnetic signal corresponding to the encoded binary data.

18. A system for communication, comprising:
a frequency selective surface having a tunable radar cross section configured to receive an electromagnetic signal, the frequency selective surface comprising:
an isolation layer;
a plurality of conductive elements disposed on a first side of the isolation layer; and
a plurality of tunable components, each tunable element coupled with a respective conductive element of the plurality of conductive elements;
a control system configured to adjust a bias voltage applied to each tunable component of the plurality of tunable components to modulate a radar cross section of the frequency selective surface to encode binary data in a reflected electromagnetic signal following receipt of the electromagnetic signal by the frequency selective surface;
a radar system configured to transmit the electromagnetic signal and receive the reflected electromagnetic signal; and
the frequency selective surface is configured to operate within a frequency band corresponding to an operational frequency of the radar system;
wherein:
the frequency selective surface includes a ground layer disposed on a second side of the isolation layer opposite the plurality of conductive elements,
the frequency selective surface includes a substrate layer disposed on the first side of the isolation layer,
each tunable component of the plurality of tunable components includes a PIN diode,
the control system is configured to adjust the bias voltage applied to each PIN diode to modulate the frequency selective surface between a high radar cross section state and a low radar cross section state,
an increase to the bias voltage modulates the frequency selective surface to the low radar cross section state,
a decrease to the bias voltage modulates the frequency selective surface to the high radar cross section state,
the high radar cross section state represents a binary of 1,
the low radar cross section state represents a binary of 0, and
the radar system comprises a signal processor configured to decode a variation in the reflected electromagnetic signal corresponding to the encoded binary data.

19. A method for communication, comprising:
providing a system for communication, comprising:
a frequency selective surface having a tunable radar cross section configured to receive an electromagnetic signal, the frequency selective surface comprising:
an isolation layer;
a plurality of conductive elements disposed on a first side of the isolation layer; and
a plurality of tunable components, each tunable component coupled with a respective conductive element of the plurality of conductive elements;
a control system configured to adjust a bias voltage applied to each tunable component of the plurality of tunable components to modulate a radar cross section of the frequency selective surface to encode binary data in a reflected electromagnetic signal following receipt of the electromagnetic signal by the frequency selective surface;
a radar system configured to transmit the electromagnetic signal and receive the reflected electromagnetic signal; and
the frequency selective surface is configured to operate within a frequency band corresponding to an operational frequency of the radar system
transmitting an electromagnetic signal toward the frequency selective surface;
adjusting the bias voltage applied to the plurality of tunable components of the frequency selective surface to modulate the radar cross section to encode binary data in the reflected electromagnetic signal; and
decoding the binary data from the reflected electromagnetic signal.

20. The method of claim 19, wherein modulating the radar cross section includes switching the frequency selective surface between a high radar cross section state representing a binary of 1 and a low radar cross section state representing a binary of 0.
